(19) United States
(12) Patent Application Publication
(10) Pub. No.: US 2007/0290589 A1
(43) Pub. Date: Dec. 20, 2007

(54) Plasma display apparatus

(76) Inventor: Dong-Hyok Shin, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/806,168

(22) Filed: May 30, 2007

(30) Foreign Application Priority Data
Jun. 20, 2006 (KR) 10-2006-0055408

(51) Int. Cl. H01J 61/52

(52) U.S. Cl. 313/46

(57) ABSTRACT

Exemplary embodiments relate to a plasma display apparatus. The plasma display apparatus may include a plasma display panel, a chassis disposed on a rear of the plasma display panel, and a grounding member disposed between the plasma display panel and the chassis. The grounding member may be attachably and detachably coupled to the chassis. The chassis may be non-electro-conductive.

### BACKGROUND

1. Field of Art

Exemplary embodiments relate to a plasma display apparatus.

2. Description of the Related Art

A plasma display apparatus using a plasma display panel may be recognized as a flat panel display apparatus. The flat panel display apparatus may display an image using a gas discharge, for example, which may become one of the next generation flat panel display devices due to its excellent display characteristics, e.g., high brightness, contrast, large viewing angle, and a thin and large screen.

To manufacture a lightweight plasma display apparatus, the thickness of a chassis that supports a plasma display panel should be small or be formed from a light material. However, maintaining the small thickness or weight of the chassis while increasing the size of the plasma display apparatuses may have its drawbacks, e.g., structural problems may result if the thickness of the chassis is excessively thin. Accordingly, manufacturers of plasma display apparatus must consider the structural safety of the chassis when reducing the thickness of the chassis. To solve the disadvantages in a conventional plasma display apparatus, a proposal has been to use lightweight plastic to form the chassis instead of the conventional material of aluminum. However, when using plastic materials to form the chassis, the chassis may generally be non-electro-conductive, which cannot be grounded. For instance, a circuit unit disposed in the chassis cannot be grounded through the chassis due to the non-electro-conductive property.

### SUMMARY

Exemplary embodiments are therefore directed to a plasma display apparatus, which substantially overcomes one or more of the problems due to the limitations and disadvantages of the related art.

It is therefore a feature of an exemplary embodiment to provide a plasma display apparatus that may be lightweight.

It is therefore another feature of an exemplary embodiment to provide a plasma display apparatus having an improved grounding performance.

At least one of the above and other features and advantages of exemplary embodiments may provide a plasma display apparatus having a plasma display panel, a chassis disposed on a rear of the plasma display panel, and a grounding member disposed between the plasma display panel and the chassis. The grounding member may be attachably and detachably coupled to the chassis. The chassis may be non-electro-conductive.

At least one of the above and other features of exemplary embodiments may provide the chassis having a base part and a plurality of first fixing parts formed on the base part. The grounding member may be disposed on a front surface of the chassis by the first fixing parts. The first fixing parts may be formed along edges of the base part. The first fixing parts may be in a shape of a hook.

At least one of the above and other features of exemplary embodiments may provide the chassis having a plurality of second fixing parts which may be formed on the base part. The second fixing parts may attachably and detachably couple the chassis to the plasma display panel. The second fixing parts may be formed along edges of the base part. The first fixing parts and the second fixing parts may be formed to substantially correspond to each other. The second fixing parts may be in a shape of a hook.

At least one of the above and other features of exemplary embodiments may provide the grounding member being formed of a material containing metal. The metal may be selected from at least one of an iron, a copper, an aluminum and a composite of these metals. The grounding member may be in a shape of a thin film sheet.

At least one of the above and other features of exemplary embodiments may provide the chassis being made from a plastic material.

At least one of the above and other features of exemplary embodiments may provide the plasma display apparatus having a circuit unit disposed on a rear of the chassis and grounded to the grounding member.

At least one of the above and other features of exemplary embodiments may provide the adhesive member being disposed between the grounding member and the plasma display panel so as to couple the grounding member to the plasma display panel. The adhesive member may be a double-sided tape.

### BRIEF DESCRIPTION OF THE DRAWINGS

The above and other features and advantages of the present invention will become more apparent by describing in detail exemplary embodiments thereof with reference to the attached drawings, in which:

FIG. 1 illustrates a cross-sectional view of a plasma display apparatus according to an exemplary embodiment;

FIG. 2 illustrates a perspective view of a partial assembly of a coupling structure of a grounding member and a chassis as illustrated in FIG. 1, according to an exemplary embodiment;

FIG. 3 illustrates an enlarged view of portion A of the plasma display apparatus as depicted in FIG. 1; and

FIG. 4 illustrates a cross-sectional view of a plasma display apparatus according to another exemplary embodiment.

### DETAILED DESCRIPTION OF EXEMPLARY EMBODIMENTS

Korean Patent Application No. 10-2006-0055408, filed on Jun. 20, 2006, in the Korean Intellectual Property Office, and entitled: “Plasma Display Apparatus,” is incorporated by reference herein in its entirety.

Exemplary embodiments will now be described more fully hereinafter with reference to the accompanying drawings. The invention may, however, be embodied in different forms and should not be construed as limited to the embodiments set forth herein. Rather, these exemplary embodiments are provided so that this disclosure will be thorough and complete, and will fully convey the scope of the invention to those skilled in the art.

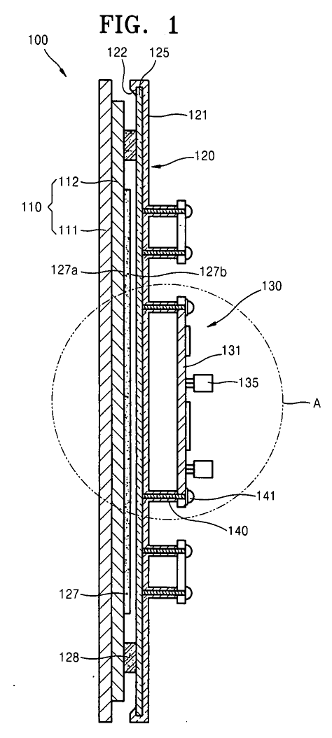

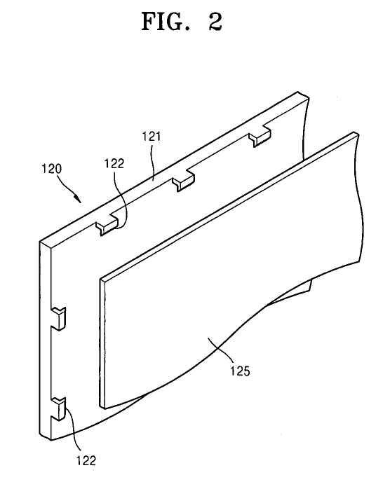

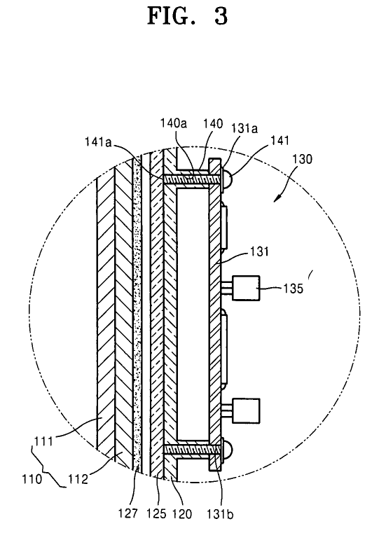

A plasma display apparatus 100 according to exemplary embodiments is depicted in FIGS. 1 through 3. FIG. 1 illustrates a cross-sectional view of the plasma display apparatus 100 according to exemplary embodiments. FIG. 2 illustrates a perspective view of a partial assembly of a coupling structure of a grounding member 125 and a chassis 120 as illustrated in FIG. 1, and FIG. 3 illustrates an enlarged view of portion A of the plasma display apparatus as illustrated in FIG. 1.

Referring to FIG. 1, the plasma display apparatus 100 may include a plasma display panel 110, a chassis 120, a circuit unit 130, a thermal conduction sheet 127, a grounding member 125, and adhesive members 128. The plasma display panel 110 may display an image using a gas discharge, for example. The plasma display panel 110 may include a front panel 111 and a rear panel 112 coupled to each other. The front and rear panels 111 and 112 may be, in a generally rectangular shape. However, it should be appreciated that the front and rear panels 111 and 112 may be in other shapes, such as, but not limited to, a rectangle, a square, a quadrangular or a regular (or irregular) polygonal shape. The front panel 111 may have a longer horizontal length than the rear panel 112. The front panel 111 may further have a smaller or reduced vertical length than the rear panel 112.

The chassis 120 may be disposed on a rear of the plasma display panel 110 to support the plasma display panel 110. The chassis 120 may be of a non-electro-conductive material, such as, a plastic material, e.g., an expanded polypropylene (EPP). It should be appreciated by one skilled in the art that other materials may be employed to form the chassis. The chassis 120 may include a base part 121 and a plurality of fixing parts 122. The base part 121 may substantially have a flat rectangular shape. Similarly, as discussed above, other shapes may be employed for the base part 121. Referring to FIG. 2, the fixing parts 122 may be formed along edges of the base part 121, e.g., on upper, lower, left, and right edges of the chassis 120. The fixing parts 122 may be in a shape of a hook, for example. However, it should be appreciated that other shapes may be employed to form the fixing parts 122.

The grounding member 125 may be disposed on a front surface of the base part 121, and may be secured by the fixing parts 122. It should further be appreciated that other means besides the hook shaped fixing part 122 may be employed to dispose the grounding member 125 to the chassis 120. Further, the grounding member 125 may be attachably and detachably coupled to the chassis 120. The grounding member 125 may be in a shape of a rectangular thin film sheet. The grounding member 125 may be of a material containing a metal, such as, but not limited to, an iron, a copper, aluminum, or a composite of these metals.

The adhesive members 128 may be disposed between the plasma display panel 110 and the grounding member 125. The adhesive members 128 may be formed of various materials, such as, double-sided tapes as illustrated in FIG. 1. The adhesive members 128 may be disposed along edges of the plasma display panel 110. If the plasma display panel 110 and the chassis 120 are directly attached by the adhesive members 128, there may be difficulty in separating the plasma display panel 110 from the chassis 120 when the chassis 120 is being repaired since the adhesive members 128 may be heated prior to separation. In accordance to exemplary embodiments, the adhesive members 128 are not directly attached to the chassis 120, but are attached to the grounding member 125. Therefore, the chassis 120 may be readily separated from the plasma display panel 110.

It should be appreciated by one skilled in the art that other means besides the adhesive members 128 may be employed to attach the plasma display panel 110 to the chassis 120.

The thermal conduction sheet 127 may be disposed between the grounding member 125 and the plasma display panel 110. The thermal conduction sheet 127 may correspond to a central portion of the plasma display panel 110. Although FIG. 1 illustrates only one thermal conduction sheet 127 disposed between the grounding member 125 and the plasma display panel 110, it should be appreciated that there may be more than one conduction sheet 127. For example, there may be at least two thermal conduction sheets disposed between the grounding member 125 and the plasma display panel 110. A front surface 127a of the thermal conduction sheet 127 may tightly contact the plasma display panel 110, and a rear surface 127b of the thermal conduction sheet 127 may be separated from the grounding member 125 to form a gap (e.g., opening, space, cavity, slit, crack, etc.) between the thermal conduction sheet 127 and the grounding member 125. Accordingly, the thermal conduction sheet 127 may dissipate heat generated by the plasma display panel 110 to the surroundings, e.g., heat may be discharged to the outside by exchanging heat with air entering through the gap.

Referring to FIG. 3, the circuit unit 130 may be on a rear of the chassis 120. The circuit unit 130 may include a plurality of substrates 131 to drive the plasma display panel 110. The substrates 131 may be separated from the chassis 120 by bosses 140, for example, having screw threads on an inner circumference 140a thereof. It should be appreciated that the bosses 140 may be formed separately from the chassis 120, but may be manufactured in one unit with the chassis 120 for manufacturing convenience.

Referring to FIG. 3, circuit lines (not shown) may be formed on the substrate 131 to process electrical signals. Electronic elements 135 may be mounted on the circuit lines. Further, a plurality of through-holes 131b may be formed on the substrate 131 so that screws 141 may be inserted and screwed into the bosses 140. A grounding part 131a, which may surround at least one of the through-holes 131b, may be formed on the substrate 131. At least one circuit line of the circuit lines may supply a grounding voltage, and may be electrically connected to the grounding part 131a. The screw 141, which may be electro-conductive, may be inserted into one of the through-holes 131b and coupled to the boss 140. Moreover, an end 141a of the screw 141 may contact the grounding member 125. The grounding member 125 may supply a grounding voltage to the substrate 131 because the grounding part 131a, the screw 141, and the grounding member 125 are all each electrically connected. In other exemplary embodiments, the bosses 140 may also be formed of an electro-conductive material. When the bosses 140 are formed of an electro-conductive material, the grounding member 125 may supply a grounding voltage to the substrate 131 when the end of the bosses 140 contacts the grounding member 125 even if the screw 141 does not directly contact the grounding member 125.

The circuit unit 130 may transmit electrical signals to the plasma display panel 110 through signal transmitting members (not shown). The signal transmitting member may be at least one of a flexible printed cable (FCB), a tape carrier package (TCP), and a chip on film (COF).

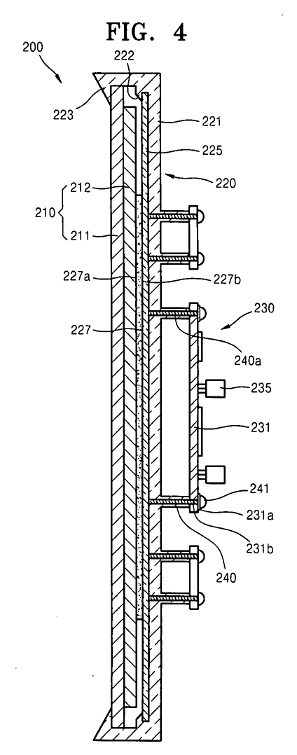

FIG. 4 illustrates a cross-sectional view of a plasma display apparatus 200 according to another exemplary embodiment.

Referring to FIG. 4, the plasma display apparatus 200 may include a plasma display panel 210, a chassis 220, a circuit unit 230, a thermal conduction sheet 227, and a grounding member 225. The plasma display panel 210 may include a front panel 211 and a rear panel 212 coupled to each other.

The chassis 220 may be disposed on a rear of the plasma display panel 210 to support the plasma display panel 210. The chassis 220 may be formed of a non-electro-conductive material, such as, a plastic material, for example. It should be appreciated by one skilled in the art that other materials may be employed to form the chassis. The chassis 220 may include a base part 221, first fixing parts 222, and second fixing parts 223. The base part 221 may be in a substantially flat rectangular shape. However, it should be appreciated that the base part 221 may be in other shapes, such as, but not limited to, a rectangle, a square, a quadrangular and a regular or irregular polygonal shape. Referring to FIG. 4, the first fixing parts 222 and the second fixing parts 223 may be formed along edges of the base part 221. Further, the plurality of the first fixing parts 222 and the second fixing parts 223 may be respectively formed on upper, lower, left, and right edges of the chassis 220. The second fixing parts 223 may be substantially formed corresponding to the first fixing parts 222. The second fixing parts 223 may also be formed at other locations than the first fixing parts 222 on the base part 221. The first fixing parts 222 and the second fixing parts 223 respectively may be in a shape of a hook. It should be appreciated that other shapes may be employed to form the first fixing parts 222 and the second fixing parts 223.

The grounding member 225 may be disposed on a front surface of the base part 221. Moreover, the grounding member 225 may be fixed on the front surface of the base part 221 by pressing the first fixing parts 222 against the ground member 225. Accordingly, the grounding member 225 may be attachably and detachably coupled to the chassis 220. The grounding member 225 may be in a shape of a rectangular thin film sheet, and may be formed of a material containing a metal, such as, but not limited to, an iron, a copper, an aluminum or a composite of these metals.

The plasma display panel 210 may be fixed on the front of the grounding member 225 by the second fixing parts 223. The plasma display panel 210 and the chassis 220 may be attachably and detachably coupled without an additional member, such as an adhesive member. Further, repairing and reuse of an element may be facilitated because the plasma display panel 210, the grounding member 225, and the chassis 220 are readily separatable from each other.

The thermal conduction sheet 227 may be disposed between the grounding member 225 and the plasma display panel 210. The thermal conduction sheet 227 may correspond to a central portion of the plasma display panel 210. It should be appreciated that one or multiple thermal conduction sheets 227 may be between the grounding member 225 and the plasma display panel 210.

The circuit unit 230 may be disposed on a rear of the chassis 220. The circuit unit 230 may include a plurality of substrates 231 to drive the plasma display panel 210. The substrates 231 may be separated from the chassis 220 by bosses 240, for example. The bosses 240 may include screw threads in an inner circumference 240a thereof. The bosses 240 can be formed separately from the chassis 220, but, as illustrated in FIG. 4, it should be appreciated that the bosses 240 may be manufactured in one unit with the chassis 220 for manufacturing convenience.

Circuit lines (not shown) may be formed on the substrate 231 to process electrical signals. Electronic elements 235 may be mounted on the circuit lines. Further, a plurality of through-holes 231b may be formed on the substrate 230 so that screws 241 may be inserted and screwed into the bosses 240. A grounding part 231a that surrounds at least one of the through-holes 231b may be formed on the substrate 231. At least one circuit line of the circuit lines may supply a grounding voltage, and may be electrically connected to the grounding part 231a. A conductive screw 241, which may be electro-conductive, may be inserted into the through-holes 231b and coupled to the boss 240. Moreover, an end 241a of the screw 241 may contact the grounding member 225. The grounding member 225 may supply a grounding voltage to the substrate 231 because the grounding part 231a, the screw 241, and the grounding member 225 are all each electrically connected. In other exemplary embodiments, the bosses 240 may also be formed of an electro-conductive material. When the bosses 240 are formed of an electro-conductive material, the grounding member 225 may supply a grounding voltage to the substrate 231 when the end of the bosses 240 contact the grounding member 225 even if the screw 241 does not directly contact the grounding member 225.

The circuit unit 230 may transmit electrical signals to the plasma display panel 210 through signal transmitting members (not shown). The signal transmitting member may be at least one of a CB, a CP, and a OF.

Exemplary embodiments relate to a plasma display apparatus which may be manufactured to be light weight because the chassis may be formed from a plastic material, for example. Moreover, a grounding member may increase the grounding performance of a circuit unit. The grounding member and the plasma display panel may be attachably and detachably coupled to a chassis using first fixing parts and second fixing parts. As a result, the plasma display apparatus, i.e., the separation of the plasma display panel and the chassis, may be easily manufactured and easily separated.

In the figures, the dimensions of layers and regions may be exaggerated for clarity of illustration. It will also be understood that when an element or layer is referred to as being “on”, “disposed on” or “connected to” another element or layer, it can be directly on, directly disposed on or connected to the other element or layer or intervening elements or layers may be present. In contrast, when an element is referred to as being “directly on,” “directly disposed on” or “directly connected to” another element or layer, there are no intervening elements or layers present. Further, it will be understood that when a layer is referred to as being “under” or “above” another layer, it can be directly under or directly above, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

It will also be understood that, although the terms “first” and “second” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of exemplary embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or layers described as “below” or “beneath” other elements or layers would then be oriented “above” the other elements or layers. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized embodiments (and intermediate structures) of exemplary embodiments. As such, variations from the shapes of the illustrations as a result, for exemplary, of manufacturing techniques and/or tolerances, are to be expected. Thus, exemplary embodiments should not be construed as limited to the particular shapes of regions illustrated herein but are to include deviations in shapes that result, for exemplary, from manufacturing. For exemplary, a panel illustrated as a rectangle will, typically, have rounded or curved features at its edges. Thus, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display apparatus, comprising:
a plasma display panel;
a chassis disposed on a rear of the plasma display panel, the chassis is non-electro-conductive; and
a grounding member disposed between the plasma display panel and the chassis, the grounding member being attachably and detachably coupled to the chassis.

2. The plasma display apparatus as claimed in claim 1, wherein at least a portion of the grounding member is electro-conductive

3. The plasma display apparatus as claimed in claim 1, wherein the chassis further comprises a base part, and a plurality of first fixing parts formed on the base part, wherein the grounding member is on a front surface of the chassis by the first fixing parts.

4. The plasma display apparatus as claimed in claim 3, wherein the first fixing parts are formed along edges of the base part.

5. The plasma display apparatus as claimed in claim 3, wherein the first fixing parts is in shape of a hook.

6. The plasma display apparatus as claimed in claim 3, wherein the chassis further comprises a plurality of second fixing parts formed on the base part so as to attachably and detachably couple the chassis to the plasma display panel.

7. The plasma display apparatus as claimed in claim 6, wherein the second fixing parts are formed along the edges of the base part.

8. The plasma display apparatus as claimed in claim 6, wherein the second fixing parts is in shape of a hook.

9. The plasma display apparatus as claimed in claim 6, wherein the first fixing parts and the second fixing parts are formed to substantially correspond to each other.

10. The plasma display apparatus as claimed in claim 1, wherein the grounding member includes a material containing a metal.

11. The plasma display apparatus as claimed in claim 10, wherein the metal is selected from at least one of an iron, a copper, an aluminum and a composite of these metals.

12. The plasma display apparatus as claimed in claim 1, wherein the grounding member is in a shape of a thin film sheet.

13. The plasma display apparatus as claimed in claim 1, wherein the chassis is composed from a plastic material.

14. The plasma display apparatus as claimed in claim 13, wherein the plastic material is an expanded polypropylene (EPP).

15. The plasma display apparatus as claimed in claim 1, further comprising a circuit unit disposed on a rear of the chassis and grounded to the grounding member.

16. The plasma display apparatus as claimed in claim 15, wherein the circuit unit includes a substrate to drive the plasma display panel.

17. The plasma display apparatus as claimed in claim 16, wherein the substrate is separated from the chassis by bosses having screw threads on an inner circumference thereof.

18. The plasma display apparatus as claimed in claim 1, further comprising adhesive member disposed between the grounding member and the plasma display panel so as to couple the grounding member to the plasma display panel.

19. The plasma display apparatus as claimed in claim 18, wherein the adhesive member is a double-sided tape.

20. The plasma display apparatus as claimed in claim 19, wherein the adhesive member is disposed along edges of the plasma display panel.
